(19) United States
(12) Patent Application Publication
(10) Pub. No.: US 2006/0280047 A1
(43) Pub. Date: Dec. 14, 2006

(54) Writing instrument incorporating a digital audio player

(76) Inventor: Sun Yu, Berkley, MI (US)

Correspondence Address: GIFFORD, KRASS, GROH, SPRINKLE & CITKOWSKI, P.C, PO BOX 7021, TROY, MI, 48007-7021, US

(21) Appl. No.: 11/439,652

(22) Filed: May 24, 2006

Related U.S. Application Data
(60) Provisional application No. 60/684,081, filed on May 24, 2005.

(51) Int. Cl. G11B 21/08

(52) U.S. Cl. 369/30.01

(57) ABSTRACT

An audio player is provided that includes a digital audio player and a writing instrument incorporated within a housing. Integration of the digital audio player into a pen facilitates transcription. A method for transcribing audio information with the audio player includes playing a digital audio file on the player and creating graphical markings with the writing instrument indicative of the file contents. Ideally, the digital audio player portion is coupled to an electronic device dockable plug facilitating transfer of digital data between the digital audio player and an electronic device.

### RELATED APPLICATION

This application claims priority of U.S. Provisional Patent Application Ser. No. 60/684,081 filed May 24, 2005, which is incorporated herein by reference.

### FIELD OF THE INVENTION

The present invention in general relates to a writing instrument incorporating a digital audio player and in particular to a writing instrument containing a digital audio player with a computer dockable port contained therein.

### BACKGROUND OF THE INVENTION

The MP3 player has become a popular format for storing and playing digital media. The popularity of this format in part rests in the ability to dock the player to an electronic device and thereby download selected digital audio programs onto the player without resort to a rotating information storage device. Current digital audio players are constructed in the form of a card insertable into a slot of an electronic device such as a computer or as a freestanding portable player intended to secure to a waistband or belt. Unfortunately, these formats for a digital audio player, while well suited for platform usage or physical activity, respectively, represent an awkward format for academic and office environments.

Currently, the testing of spoken language comprehension is limited to a speaker communicating text to a collected group of students. This approach invariably leaves some students under stimulated while other students struggle to keep pace.

Regardless of the specifics of the academic or office setting, a digital audio player integral with a pen housing places audio function controls in the hand of a user during the process of writing. As such, the act of transcribing spoken language or music is greatly facilitated. Additionally, a user listening to audio programming independent of a work task can readily stop the audio programming in the event that the process of writing consumes their attention. Thus, there exists a need for a digital audio player integrated within a pen housing.

### SUMMARY OF THE INVENTION

An audio player is provided that includes a digital audio player and a writing instrument incorporated within a housing. Integration of the digital audio player into a pen facilitates transcription. A method for transcribing audio information with the audio player includes playing a digital audio file on the player and creating graphical markings with the writing instrument indicative of the file contents. Ideally, the digital audio player portion is coupled to an electronic device dockable plug facilitating transfer of digital data between the digital audio player and an electronic device.

### BRIEF DESCRIPTION OF THE DRAWINGS

FIG. 1 is a partial cutaway exploded side view of an inventive device in an assembled form.

### DETAILED DESCRIPTION OF THE INVENTION

The present invention has utility as a writing instrument storing and allowing for the playing of digital audio programs. The integration of a digital audio player into a pen facilitates transcription. Preferably, the digital audio player is detachable from the writing instrument portion to expose a computer dockable port for the transfer of files between an inventive device and a digital audio file source. Optionally, a cap is provided to protect the port when the digital audio player component is operated remote from the writing instrument component of the housing. Suitable formats for an inventive digital audio player illustratively include MP3, MP4, OGG, WAV and WMA.

As used herein, a “writing instrument” is defined to include an ink pen, a mechanical pencil, a felt tip pen and a stylus operative for data entry in an electronic device such as a PDA.

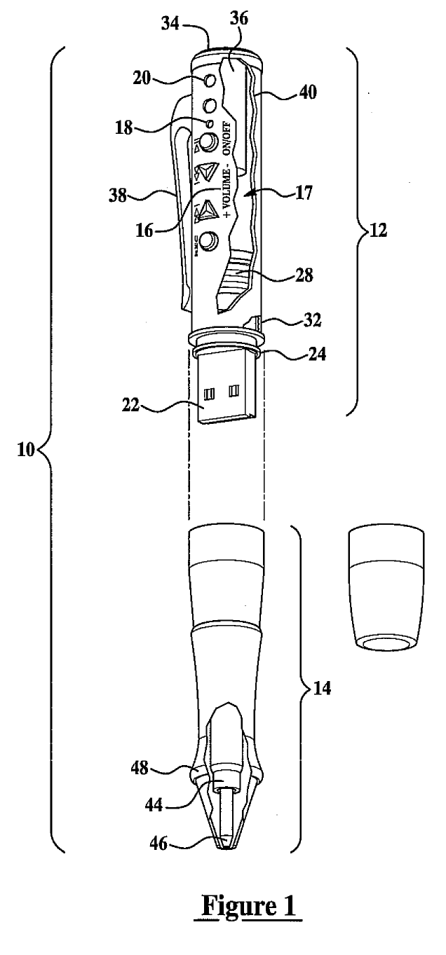

The present invention is further detailed with reference to FIG. 1 which illustrates an inventive writing instrument device generally at 10. The device 10 includes a two-part housing having an outer surface and defining an upper portion 12 and a lower portion 14. The upper portion 12 includes a fully functional digital audio player 17 including control functions 16 extending from the upper portion 12. The control functions typically include an on/off switch, volume modulation and a play function. Additional optional controls include fast forward, rewind, and record functions. Preferably, a light emitting diode (LED) indicator 18 is provided to indicate if the digital audio player 17 is energized. Optionally, additional LED indicators are provided to communicate status as to a status illustratively including battery charge, engagement of a headphone or earphone, and whether the digital audio player is in play, fast forward, rewind, or record mode. The upper portion 12 includes a computer dockable port 22 in electronic communication with a memory chip (not shown) of the digital audio player 17. The port 22 is appreciated to be any format suitable for data transfer with a computer or portable electronic device. By way of example, the port 22 illustratively includes USB, serial, parallel, SCSI, Ethernet, IEEE 1394, and a wireless interface. In the embodiment depicted in FIG. 1, port 22 is a USB port. The port 22 is exposed by separating the upper portion 12 from the lower portion 14. Any conventional coupling is operative herein and illustratively includes threads, a retention ridge, bayonet, and friction fit. The coupling includes a recessed diameter 24 complementary to a larger diameter opening 26 and a lower portion 14. While it is depicted in the figure that the recessed diameter 24 is on the upper portion 12 and the larger diameter opening 26 is on the lower portion 14, it is appreciated that these are readily reversed and remain complementary.

Also within the upper portion 12 is a battery 28. The battery 28 is preferably a button-type battery. More preferably, the battery 28 is rechargeable through the port 22 thereby allowing the upper portion 12 to remain a sealed housing so as to enhance the durability upon exposure to environmental hazards such as moisture and particulate. Alternatively, threads 32 are provided proximal to the recessed diameter 24 to allow access to a battery compartment to facilitate replacement of disposable batteries. The end 34 of the upper portion 12 includes a stereo jack 36 adapted to receive a conventional earphone or headphone. A 3.5 millimeter stereo jack is exemplary of a jack 36 operative herein. Alternatively, it is appreciated that a wireless earphone or headphone can receive a signal from the digital audio player 17 with the inclusion of a wireless antenna (not shown) within the upper portion 12.

Optionally, a clip 38 is secured to the upper portion 12 to facilitate selective attachment of an inventive device to a garment, pad of paper or the like. The skin 11 of the upper portion 12 is formed of a variety of crush-resistant materials illustratively including polycarbonate, ABS, steel, titanium, aluminum and other materials conventional to the formation of a pen skin.

In the embodiment depicted in FIG. 1, the lower portion 14 is operative as an ink pen. The lower portion 14 includes an ink cartridge 44. Preferably, the ink cartridge is retractable and when in a retracted position does not protrude beyond the writing tip 46. The lower portion 14 having a retractable ink reservoir 44 is brought into a writing position through a conventional and well known activation process, illustratively including twisting the tip portion 46, twisting relative to the large diameter opening 26, and triggering a compression spring. Optionally, the lower portion 14 is overlayered with an elastic covering 48 to facilitate gripping.

1. An audio player comprising:
a digital audio player;
a writing instrument; and
a housing containing said digital audio player and said writing instrument therein.

2. The player of claim 1 wherein said housing is partitioned into a top portion containing said digital audio player and a lower portion containing said writing instrument.

3. The player of claim 2 further comprising a coupling selectively joining the top portion and the lower portion.

4. The player of claim 1 wherein said writing instrument is an ink pen.

5. The player of claim 1 wherein said writing instrument is movable between a retracted position and an extended position.

6. The player of claim 1 further comprising a jack adapted to engage a headphone or an earphone plug.

7. The player of claim 6 wherein said jack is located in an end of said housing.

8. The player of claim 1 further comprising an electronic device dockable plug capable of transferring digital data between said digital audio player and an electronic device.

9. The player of claim 8 wherein said plug is located proximal to a coupling intermediate between said digital audio player and said writing instrument.

10. The player of claim 9 further comprising a cap adapted to cover said plug upon separating said digital audio player and said writing instrument.

11. The player of claim 1 further comprising a battery power supply in electrical communication with said digital audio player and internal to said housing.

12. The player of claim 1 further comprising a wireless antenna for communicating an audio output from said digital audio player to a headphone or earphone.

13. The player of claim 1 wherein said digital audio player has a format selected from the group consisting of: MP3, MP4, OGG, WAV and WMA.

14. The player of claim 1 wherein said digital audio player has an MP3 format.

15. A method for transcribing audio information comprising:
playing a digital audio file on a digital audio player; and
creating graphical markings with said writing instrument indicative of said file within the player of claim 1.

16. The method of claim 15 further comprising plugging a headphone or earphone into said digital audio player.

17. The method of claim 15 further comprising engaging an electronic device containing said digital audio file and uploading said digital audio file to said digital audio player.
